(19) United States
(12) Patent Application Publication
(10) Pub. No.: US 2011/0264585 A1
(43) Pub. Date: Oct. 27, 2011

(54) METHOD AND SYSTEM FOR MANAGING EMAIL

(76) Inventor: Melih Abdulhayoglu, Montclair, NJ (US)

(21) Appl. No.: 12/310,248

(22) PCT Filed: Sep. 5, 2007
(86) PCT No.: PCT/US2007/077649

§ 371 Date: Feb. 11, 2009

(51) Int. Cl. H04L 9/32; G06Q 30/00; G06F 15/16

(52) U.S. Cl. 705/50; 709/206; 713/158; 713/156; 713/176

(57) ABSTRACT

A system is provided for managing email and eliminating spam wherein an email client (112) is configured to receive digitally signed email (117), identify spam email, and allow a user to report digitally signed spam to a certificate authority (115) issuing the attached digital certificate.

### BACKGROUND

With the rapid growth of the Internet, the use of electronic mail (email) has become a valuable and indispensable tool for digital communications, especially in business transactions and personal communications. It is inexpensive, quick, and easy to use. Unfortunately, a significantly large proportion of email accounts and system have been inundated with “spam” or “junk mail” (hereinafter “spam”). Spam has grown to such a degree that it is effectively devaluing the use of email. Spam generally refers to unsolicited electronic messages sent to an unacceptably large number of email addresses. A “spammer” is a person or organization that generates the spam.

While spam can be a commercial advertisement or non-commercial bulk email that advocates some political or social position, some spam harms or damages the user or his computer. For example, many spam emails are used to advertise objectionable, fraudulent, or dangerous content, such as pornography, illegal pyramid schemes or to propagate financial scams. Spam may also pose serious security problems to a user's computer since spam emails are frequently used to propagate worms, viruses, Trojan horses, phishing attacks, malware, spyware, adware, extortion-ware, time bombs, cancelbots and other malicious software. Spam emails may also be used to download or activate dangerous code, such as Java applets, Javascript, and ActiveX controls. Email programs that support Hypertext Markup Language (HTML) can download malicious Java applets or scripts that execute with the mail user's privileges and permissions. Email has also been used to activate certain powerful ActiveX controls that were distributed with certain operating systems and browsers. In this case, the code is already on the user's system, but is invoked in a way that is dangerous. For instance, this existing code can be invoked by an email message to install a computer virus, turn off security checking, or to read, modify, or delete information on the user's disk drive.

Spam also depletes and wastes an organization's time, resources, network bandwidth, disk space, and system memory. It also uses valuable time to organize, filter and delete the spam. Many valid non-spam email messages may also be lost in this process. Much spam also comes from illegitimate advertisers posing or advertising as well-known companies or products.

Although various solutions have been implemented to block spam, they do not block all spam or prevent the same spammer from sending additional spam. For example, centralized and localized blacklists are common ways of blocking known spammers, but they do not block all spammers because spammers frequently change or alter the name of the sender in the email header. Whitelists are also common, but are so restricted that they nearly always block valid, non-spam email messages. Spam can also be blocked by blocking email that comes from nonexistent domains that cannot be found in the Domain Name System (DNS). However, this also results in blocking some valid email messages while failing to block other spam email. Bcc filtering may be used to reject email from unknown hosts that do not list the recipient's email address in the header of the message, but this fails to block those emails that do list the recipient's email address in the header. Filtering of client protocols such as POP3 provides relief to individual users, but still allows junk mail to be stored on the SMTP server. Other methods also include greylisting and Bayesian filtering. Unfortunately, spammers adapt and adjust to each method of eliminating spam, and thus each of the above described methods are only useful in a multi-layered approach to spam filtering. Furthermore, each of these methods fails to distinguish between valid and legitimate advertisements from the true, original advertisers, particularly when a user has requested certain advertisements.

### SUMMARY

In one of many possible embodiments, the present systems and methods provide a system for managing email and eliminating spam wherein an email client is configured to receive digitally signed email, identify spam email, and allow a user to report digitally signed spam to a certificate authority issuing the attached digital certificate. An email client as used herein could be a plug-in for existing email systems, a network monitor, a mail box monitor stored on a server, a specially designed email program, or any other method of monitoring emails coming into a mail server.

Another embodiment provides a system for eliminating spam that includes a certificate authority, wherein the certificate authority is configured to receive spam reports from one or more email clients.

Another embodiment provides a method for eliminating spam by receiving email, determining if the email is spam, and processing any email determined to be spam. Email is determined to be spam by checking the email for an anti-spam digital certificate; if the email is found to have an anti-spam digital certificate, the certificate is checked to determine if the certificate is revoked, and if it is, or if the email has no anti-spam digital certificate, then the email is classified as spam and processed.

Another embodiment provides a method for eliminating spam, including the steps of issuing a digital certificate to an advertiser, establishing a certificate account for the advertiser, receiving a spam report from an email recipient, and deducting a value from the certificate account.

The current systems and methods also provide a system for sending email advertisements by obtaining an anti-spam digital certificate from a certificate authority, obtaining a certificate account with the certificate authority, digitally signing an email advertisement with the digital certificate, and sending the email advertisement to an end user email client.

Another method for sending email advertisements includes obtaining an anti-spam digital certificate from a certificate authority, obtaining a certificate account with the certificate authority, digitally signing an email advertisement with the digital certificate, and sending the email advertisement to an end user email client.

Also provided herein is a method for managing email advertisements by receiving an email advertisement, checking the email for an anti-spam digital certificate; if the email is found to have an anti-spam digital certificate, then it is determined if the certificate is revoked, and if it is, or if the email has no anti-spam digital certificate, the email is classified and processed as spam. If the certificate is not revoked, then the email is processed according to a products or services classification on the certificate.

Also provided herein is a system for receiving email advertisements, the system including a digitally signed request to receive email advertisements and an email client configured to communicate with one or more certificate authorities.

Also described is a method for receiving email advertisements by sending to an advertiser a digitally signed request to receive email advertisements, receiving from the advertiser a digitally signed email advertisement having a digital certificate, determining whether the digital certificate has been revoked, and if said digital certificate has been revoked, classifying and processing the email as spam.

Finally, a method for verifying the authority to sell an email address is provided herein by receiving from an end user a digitally signed request to sell an email address, digitally signing the request, selling the email address to a third party, and obtaining the third party's digital signature on the request.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 depicts a diagram of an embodiment of an anti-spam system.

FIG. 2 shows a flowchart of an embodiment of a method for eliminating spam.

FIG. 2b shows a flowchart of another embodiment of a method for eliminating spam.

FIG. 3 shows a flowchart of an embodiment of a method of sending a digitally signed email advertisement.

FIG. 4 shows a flowchart of an embodiment of a method for identifying and blocking spam.

FIG. 4b shows a flowchart of another embodiment of a method for identifying and blocking spam.

FIG. 4c shows a flowchart of another embodiment of a method for identifying and blocking spam.

FIG. 5 shows a flowchart of an embodiment of a method for reporting spam.

FIG. 5b shows a flowchart of another embodiment of a method for reporting spam.

FIG. 6 shows a flowchart of an embodiment of a method for requesting email advertisements.

FIG. 7 shows a flowchart of an embodiment of a method for requesting an advertiser to sell an email address.

Throughout the drawings, identical reference numbers designate similar, but not necessarily identical, elements.

### DETAILED DESCRIPTION

The following description includes specific details in order to provide a thorough understanding of the present anti-spam system and methods of making and using it. The skilled artisan will understand, however, that the system and methods described below can be practiced without employing these specific details. Indeed, they can be modified and can be used in conjunction with products and techniques known to those of skill in the art in light of the present disclosure.

Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment

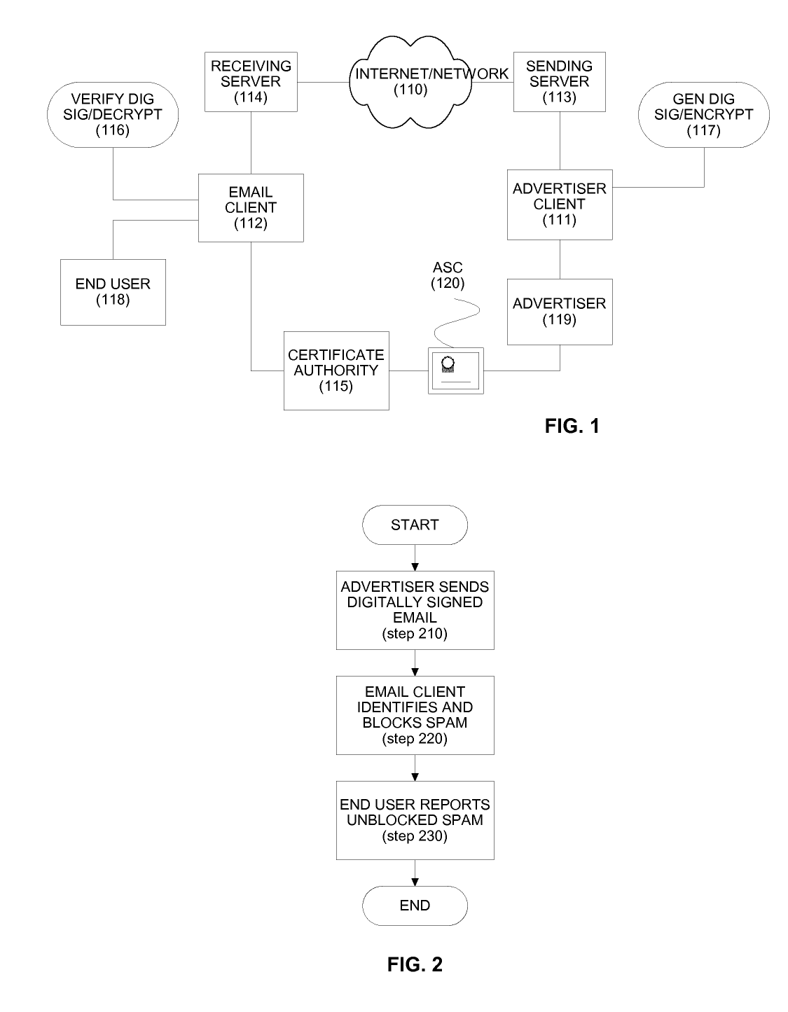

Referring now to the Figures, FIG. 1 depicts one embodiment of an email management system. FIG. 1 shows email sent over the Internet (110) where an anti-spam email client (“email client”) (112) determines if incoming email is spam or not. An email client (112) as used herein could be a plugin for existing email systems, a network monitor, a mail box monitor stored on a server, an email server designed or configured to monitor emails, an end-user email program, or any other method of monitoring emails coming into a mail server. The email client can be, but does not necessarily need to be, the same software as the end-user's email software. An advertiser or any other person or organization (hereinafter “advertiser”) (119) applies and obtains a digital anti-spam certificate (ASC) (120) from certificate authority (115). Advertiser (119) then composes an email advertisement or other message with the advertiser client (111) and digitally signs the message with encryption software (117). The ASC (120) is attached to the digitally signed message, and the advertiser (119) sends the message to end user (118). The message is delivered from advertiser client (111) to sending server (113), which routes the message over Internet (110) to receiving server (114). Receiving server (114) delivers the message to the email client (112). Email client delivers the message to decryption software (116) to decrypt the digital signature of the message. Email servers (113, 114) are typically on server machines of an internet service provider (ISP) or corporate workgroup. Other routers, bridges and gateways (not shown) are present in Internet (110). Email client (112) then communicates with certificate authority (115) to identify authorized advertisement email messages, authorized advertisers, advertisers or messages identified as spam, and to identify unblocked messages or advertisers as spam or spammers.

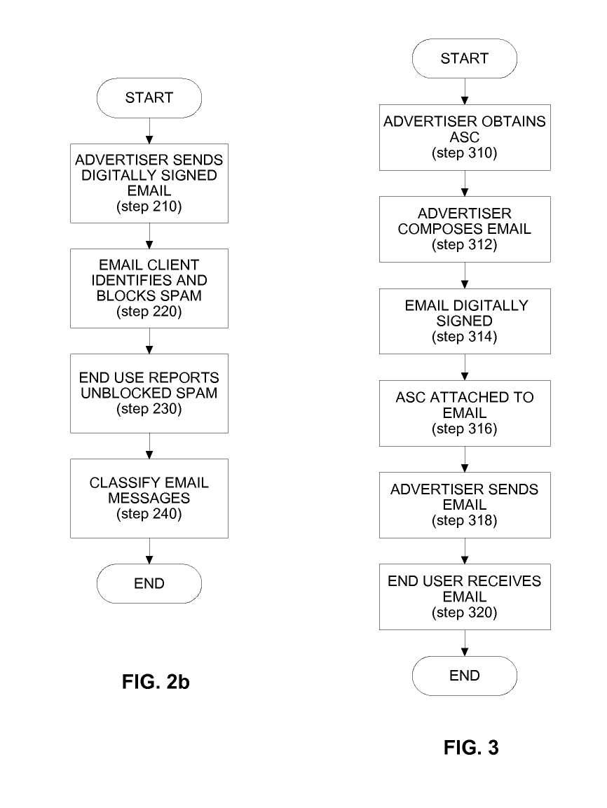

FIG. 2 depicts a general flowchart of one embodiment of a method for eliminating spam. An advertiser sends digitally signed email advertisement messages with attached ASCs to an end user (step 210). The email client then coordinates with the certificate authority that issued the attached ASCs to identify and block spam (step 220). The end user then reports any unblocked spam to the issuing certificate authority (step 230). In another embodiment, shown in FIG. 2b, the email client also classifies and processes the incoming email messages according to their classification (step 240).

Referring now to FIG. 3, a flowchart of an embodiment of sending a digitally signed email advertisement is shown. The advertiser applies for and obtains a digital anti-spam certificate (ASC) from a trusted certificate authority (step 310). In one embodiment, the advertiser provides to the certificate authority information to generate a certificate signing request (CSR). The certificate authority then generates a public key pair including a public key and a private key, and distributes the key pair and the ASC to the advertiser.

The ASC generally includes information regarding the advertiser and the ASC, such as the advertiser's name, the certificate serial number, expiration date of the certificate, the advertiser's public key associated with that certificate, and the digital signature of the certificate authority signing the ASC. The ASC may also include additional information regarding the good(s) and/or service(s) being offered in the message to which the ASC is attached.

In one embodiment, the ASC contains classification information to classify the ASC for a particular product and/or service, or class or category of products and/or services, or any other designation with which the advertiser wishes to classify the ASC. According to this method, an advertiser may obtain an ASC for each different product/service, or class of products/services it wishes to advertise. In this method, the ASC not only correlates the digital signature on the message with the advertiser, but it also correlates the digital signature with the specified product/service or class of products/services. Thus, an advertiser may have a number of different ASCs for varying products/services or classes of products/services. When used in conjunction with the present anti-spam systems and methods, this allows a single advertiser to continue to send email advertisements for successful products when other email advertisements for less-successful products are not well-received by users or recipients or are considered to be spam. It also allows the advertiser to track the success its advertisements have with end users for various products/services or classes of products/services, and to gauge users' acceptance of email message advertisements for various products/services or classes of products/services. In another embodiment, the ASC may contain information regarding the price of products/services. Indeed, the ASC may contain any classification information the advertiser wishes to use.

When the advertiser obtains an ASC, the certificate authority also establishes an associated certificate account, which includes a specified value of money or points, as chosen by the certificate authority. The certificate account may be associated with the specific certificate only, or it may apply to all certificates owned by one advertiser. Typically, the amount of money or points in the certificate account depends on the cost of the certificate or how many points the advertiser is willing to purchase. The certificate authority typically maintains records and data concerning the balance of the certificate account. The certificate account is used by the certificate authority to manage the status of the advertiser's ASC, as described in more detail below.

The advertiser then composes an email message (step 312). The message is usually an advertisement, but may be any email message from an advertiser or other individual or organization to a customer, potential customer, organization member, or other individual (“end user”). After composing the email message, the advertiser then signs the message with a digital signature (step 314). The message can be signed with a digital signature by any method known to those of skill in the art, such as creating a hash of the message and then encrypting the hash with the advertiser's private key. The advertiser's ASC is also attached to the digitally signed message before the message is sent (step 316). After the message is digitally signed and the ASC attached, the advertiser sends the digitally signed message to an end user or group of end users (step 318). The email client then receives the digitally signed email (step 320). In one embodiment, all incoming email messages received by the email client are placed into a certificate check queue before being sent to the end user's email client inbox.

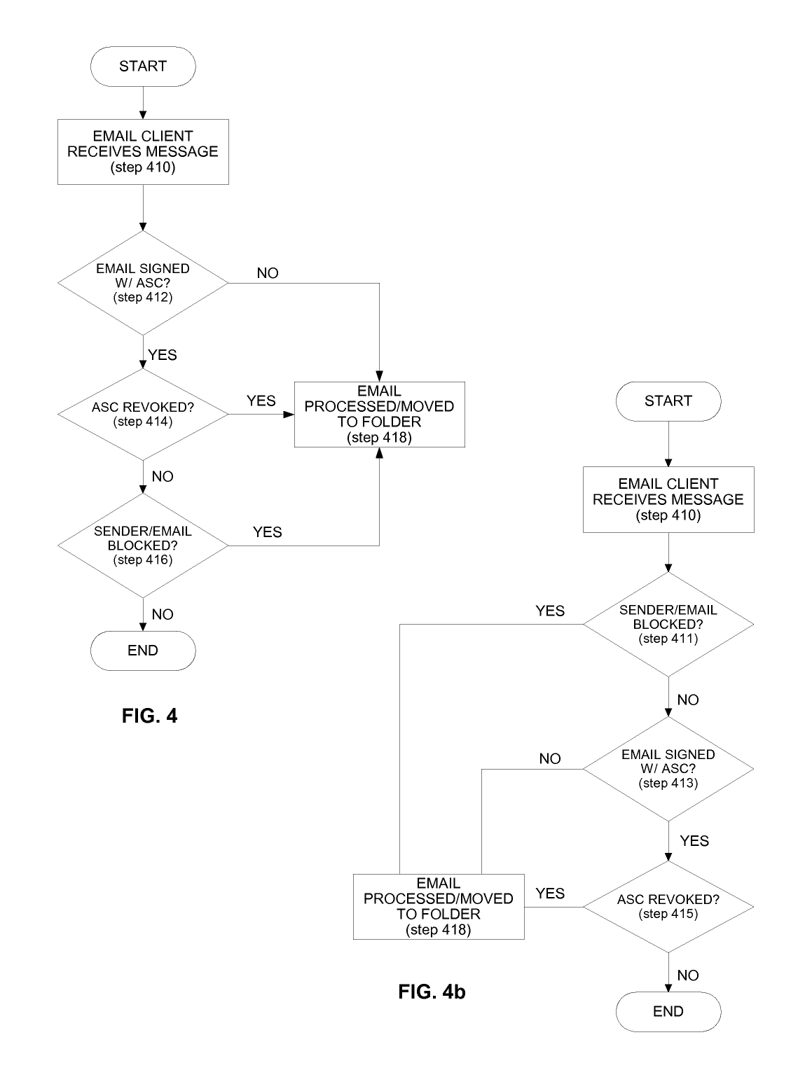

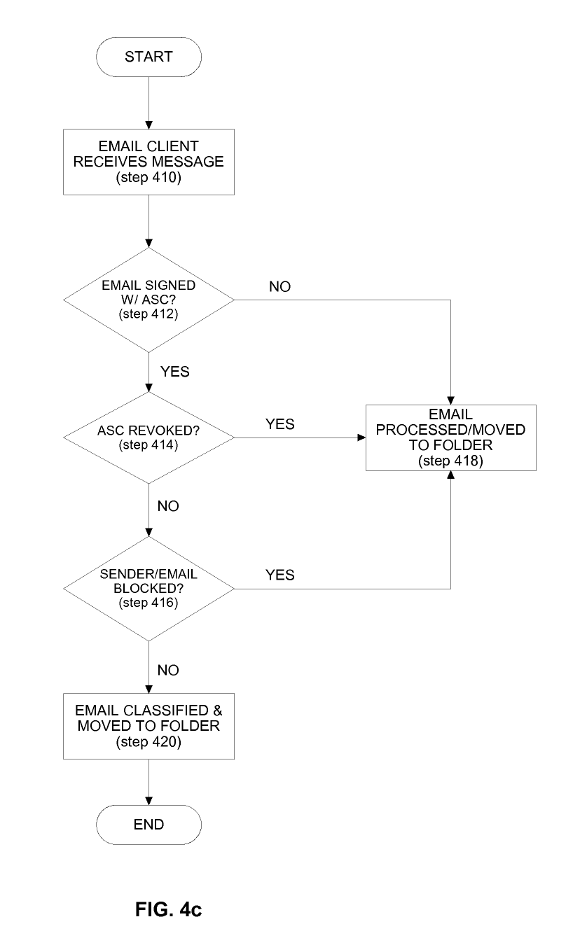

Referring now to FIG. 4, a flowchart of an exemplary method for identifying and blocking spam is shown. According to this embodiment, an incoming email message received by the email client (step 410) is checked by the email client to determine if the email message has been digitally signed with an ASC (step 412). In one embodiment the email client checks for an ASC by running a process in which the email client scans the incoming message for a digital signature or attached digital certificate. Any process for scanning for a digital certificate known to those of skill in the art may be used. If the message has not been digitally signed with an ASC, the message is then processed (moved) to a user-specified folder or location (step 418). For example, a user may configure his/her email client to forward all unsigned email messages to a folder designated “UNSIGNED,” or designated in any way desired by the user. The user may also specify all unsigned email messages to be moved to a temporary holding folder where the user can check the messages during a specified period of time before the email messages are automatically deleted. In another embodiment, the user may specify the email client to automatically delete any unsigned email message.

In one embodiment, the email client may be configured to respond to an unsigned email message by automatically sending a response email message to the sender of the unsigned email message. The response email message may explain that the user only accepts advertisements, unsolicited, or unwanted email, and/or any other email messages, if they are digitally signed with an ASC. In another embodiment the response email message may also describe the products/services, or classes of products/services for which the user accepts digitally signed advertisements.

If the email client determines that the incoming email message was digitally signed with an ASC, it will then check if the ASC is still valid or if it has been revoked (step 414). Any method known to those of skill in the art may be used to check the status of the ASC. In one embodiment the email client determines if the ASC has been revoked by accessing the issuing certificate authority's online certificate revocation list (CRL). The email client will then retrieve the status information contained in the CRL for that ASC. The status information may show that the ASC is valid or revoked. If the email client finds that the ASC has been revoked, then the message may be forwarded or processed as defined by the user (step 418). The defined forwarding or processing of the message may be identical to that specified above for unsigned email messages, or it may be different. Generally, the forwarding or other disposition of the email message may include any of the processes or dispositions described above for unsigned email messages.

If the email client determines that the ASC has not been revoked, it then checks to determine if the sender of the email message has been blocked (step 416).

In one embodiment, the sender is blocked by a blacklist defined in the email client. Any known method for blacklisting may be used, including user-defined blacklists, imported blacklists, content-based blacklists, and others known to those of skill in the art. In another embodiment, the sender may be blocked by its absence in the email client's whitelist. The whitelist may be created and implemented according to any method known to those of skill in the art. If the email client determines that the sender has been blocked, or that email messages from the particular sender are not accepted, then the email message may be forwarded or processed as defined by the user (step 418). The defined forwarding or processing of the message may be identical to that specified above for unsigned email messages or signed messages with revoked ASCs, or it may be different. Generally, the forwarding or other disposition of the blocked or unaccepted email message may include any of the processes or dispositions described above.

In another embodiment of identifying and blocking spam, shown in FIG. 4b, after the email client receives an incoming email message (step 410), the email client determines if the sender or message has been blocked or accepted (step 411). This may be done by any of the methods described above. If it is determined that the sender or message has been blocked or not accepted, then the message is forwarded or processed as defined by the email client (step 418). If it is determined that the sender or message has not been blocked, or has been accepted, then the email client then proceeds to check if the message has been signed with an ASC (step 413), and if so, if the ASC has been revoked or not (step 415). These steps may be carried out by any of the means previously described.

Referring to FIG. 4c, one embodiment of the anti-spam system is shown in which, if the email client determines that the sender has not been blocked, or that the particular message is otherwise accepted (step 416), the email client may automatically move the message to a folder within the email client depending on the classification of the email (step 420). The email may be classified by a classification of the ASC, or it may be classified by the content of the email message. In one embodiment, the user defines which folder(s) to which the email message is to be moved. For example, the user may create a “COMPUTER PRODUCTS” folder to which all incoming signed email advertisements classified as advertisements for computer products will be moved. In another embodiment, the email client may be configured to place all signed, unblocked email messages in the end-user's inbox.

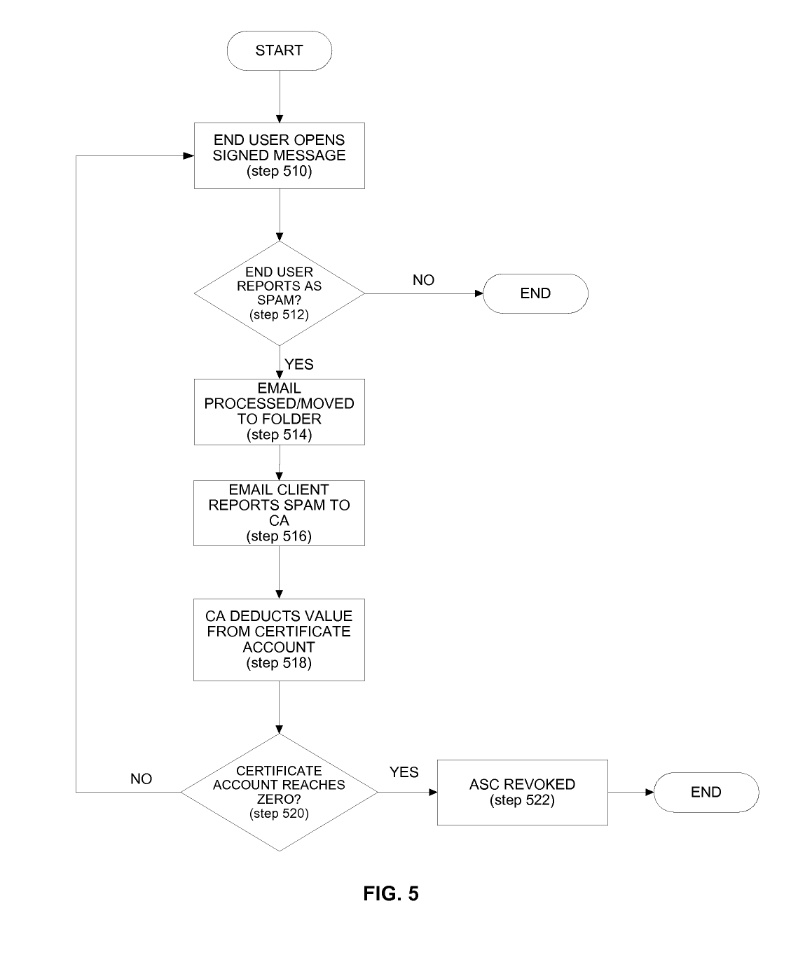

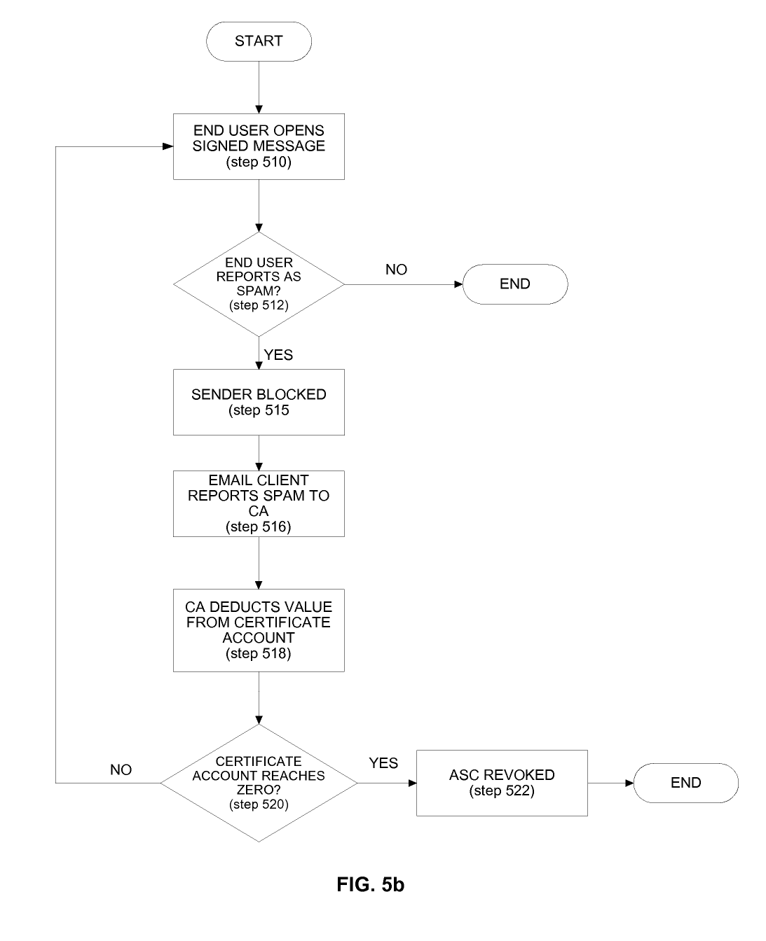

Referring now to FIG. 5, after the end user opens a digitally signed email message with an ASC (step 510), the user may then report the email message as being spam or unwanted (step 512). Since not every spam email may be filtered by the previously described processes, the email client allows the end user to report as spam email messages that have escaped through the above-described filters. In one embodiment, the user reports the email message as spam by pressing a “SPAM” or “REPORT AS SPAM” button (“spam button”) on the end-user's email software interface. By pressing the spam button, the email software moves the email message to a user-defined folder, such as a “JUNK MAIL” or “DELETE” folder (step 514). After pressing the spam button, the end-user's email software will instruct the email client to (or, if the end-user's email software is the email client, the email software itself will) extract relevant details and data about the email message and send a report to the certificate authority that issued the ASC (step 516). In one embodiment, the details and data that may be extracted from the email message and reported to the certificate authority include any data the certificate authority determines to be relevant in determining if the email message was spam. Generally, the data to be reported includes information about the content of the email, the name of the entity that signed the email message, and any other desirable information. The report may also include data concerning the time elapsed from when the user opened the email message to pressing the spam button, or other similar method for determining if the user actually considered the email message as spam and unwanted.

As stated above, when the end-user presses the spam button displayed on their email software, the email client reports to the certificate authority that the user has identified the email message as spam (step 516). This may be done by any method known to those of skill in the art. For example, in one embodiment the email client may report the spam to the certificate authority via an email message from the end-user's email software. In another embodiment, the email client establishes a connection via a network with a database or other server operated by the certificate authority and directly adds the spam report to the database or other program operated by the certificate authority. After receiving the spam report, the certificate authority will then deduct a value from the advertiser's certificate account (step 518). The amount of the value depends on the practices of the certificate authority, any agreements made between the certificate authority and the advertiser, and may vary depending on the nature of the email message, its content, its classification, etc. Each time an email message is reported by a user as spam, the certificate authority deducts a value from the certificate account. Once the certificate account balance reaches zero (step 520), the certificate authority will revoke the ASC (step 522). Thus, an email signed with an ASC may be reported as spam by users who did not wish to receive that email message. If the certificate account has not reached zero, then the email may be opened and read by other end users (step 510) since it will not be blocked by the anti-spam system. However, once the ASC is revoked due to the certificate account reaching zero (step 520), every anti-spam email client may determine that the ASC has been revoked and will forward or process the email message as defined by the user (e.g. step 412, FIG. 4).

In one embodiment, shown in FIG. 5b, when a user reports an email message as spam, the sender is added to a blacklist within the email client (step 515). Thus, when the email client checks to see if an incoming email message has been blocked, that email will be identified as spam (step 416, FIG. 4) and forwarded or processed as defined by the email client or end-user (step 418, FIG. 4) if the end-user has previously reported an email message containing the same ASC as spam.

In another embodiment, the email client is configured to allow a user to report a particular email message as spam only once. This ensures that one user does not deplete an advertiser's ASC account when the advertiser is legitimately carrying on business as a non-spammer.

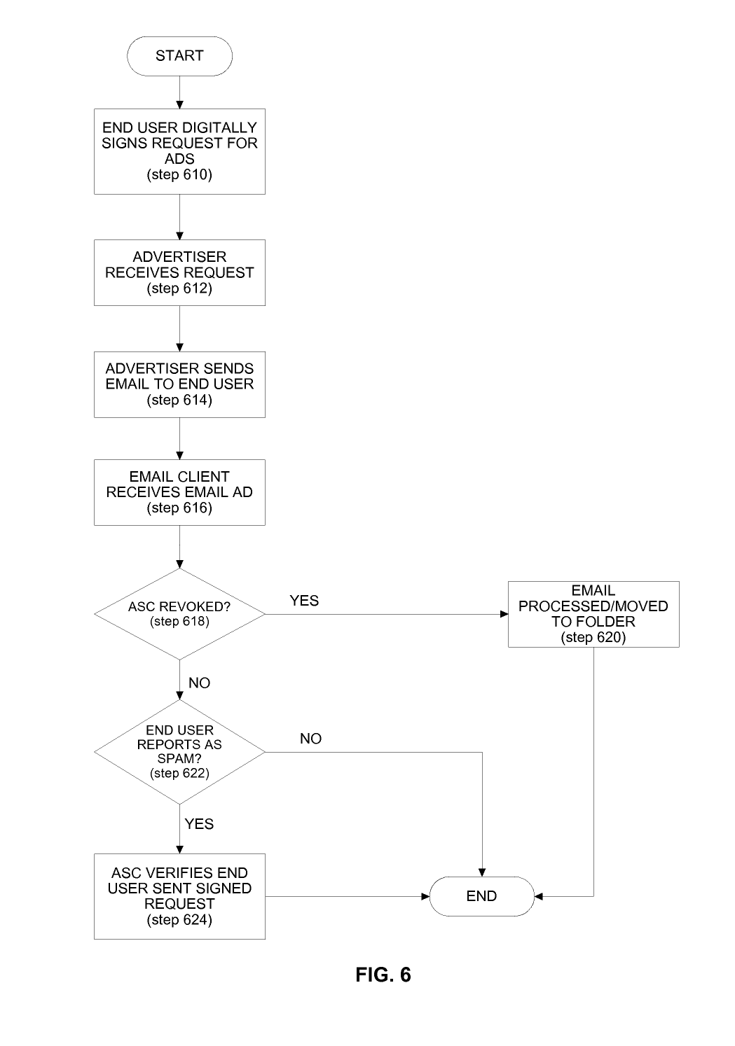

As shown in FIG. 6, the present system and methods may also include a mechanism to verify that the recipient of an email message allowed the sender to send the email message to the recipient. In one embodiment, this mechanism involves the end user digitally signing a request to send email to the end user (step 610). This request may take many forms, and includes, but is not limited to, an email request, an authentication token, an online checkbox, or any other method of digitally signing a request known to those of skill in the art. After receiving the request (step 612), the advertiser then sends a digitally signed email advertisement with an attached ASC to the end user (step 614). The email client then receives the email advertisement (step 616) and will check to see if the ASC has been revoked (step 618). If the ASC has been revoked, the email client will process or forward the email message to a user-defined folder (step 620). If the ASC has not been revoked, but the end user has reported the email as spam (622), the email client will then verify that the end user has digitally signed an authorization for the advertiser or sender to send an email message to the end user (step 624). In one embodiment, this verification step may be performed when the email client checks if the email message has been accepted per a whitelist contained within the email client (step 416, FIG. 4).

By digitally signing a request to authorize an advertiser or other sender to send email messages to the recipient, the sender can prove that the receiver allowed the sender to send email messages to the receiver. Thus, if an email message recipient receives an email message from a sender, and reports the email message as spam, the sender can verify to the certificate authority that the message was authorized by the recipient, and the certificate authority will not deduct any value or points from the sender's certificate account.

The present system and methods also provide a method of verifying that the sender has the recipient's permission to sell the recipient's email address to third parties. In one embodiment, when an advertiser sells the email address of a user to a third party advertiser the third party advertiser can verify, using cryptographic algorithms, that the user has consented to selling his/her email. The user can also verify the classes of use for that resale. For example, a user might only want an advertiser to sell his/her certificate to third parties to only receive discount coupons from them, or new product announcements, etc.

In another embodiment, when the user receives an email from a third party who has purchased his/her email address, the end user can verify that the sender does have the consent to send the message. This verification can come through the user allowing the first advertisers to sell his/her email address to a second advertiser, and the second advertiser including cryptographic details to prove that the transaction was genuine. This way the end user has the ability to check that only the authorized advertisers can send him/her an email for the intended purposes set out by him/her in a way he/she can verify it.

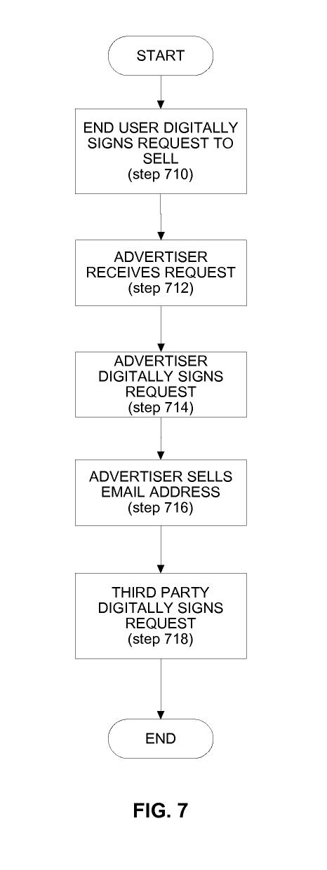

According to one embodiment, shown in FIG. 7, the end user digitally signs a request to sell the end user's email address to third parties (step 710). The purchasing third parties may be any third party, or a third party designated by the end user, the advertiser, or both. The digitally signed request to sell can take on any of the forms described above for a request to receive email messages. When the advertiser receives the request (step 712), the advertiser digitally signs the request with the advertiser's ASC (step 714). When the advertiser sells an email address to a third party (step 716), that third party also digitally signs the original request to sell (step 718). Thus, when the end user receives an email from an unknown sender, the end user can trace each sale of his email address and identify the original seller. In one particular embodiment, the end user can specify the number of allowed transactions when the end user digitally signs his request to sell. The end user's email address cannot be sold or transferred in excess of the number of transactions specified by the end user.

The preceding description has been presented only to illustrate and describe embodiments of the anti-spam email client and system and methods. It is not intended to be exhaustive or to limit the anti-spam email client and system and methods to any precise form disclosed. It is to be understood that the above-described arrangements are only illustrative of the application of the principles described herein. Modifications and alterations of may be devised by those skilled in the art without departing from the spirit and scope of the products and methods described herein, and the appended claims are intended to cover such modifications and arrangements

What is claimed is:

1. A system for eliminating spam, comprising:
an email client, wherein said email client is configured to communicate with one or more certificate authorities.

2. The system of claim 1, wherein said client is configured to communicate with said one or more certificate authorities by email.

3. The system of claim 1, wherein said client is configured to communicate with said one or more certificate authorities via a network connection to said one or more certificate authorities.

4. The system of claim 1, wherein said client is further configured to identify spam email.

5. The system of claim 1, wherein said client is further configured to allow a user to report spam email digitally signed with a digital certificate as spam to a certificate authority issuing said digital certificate.

6. The system of claim 1, wherein said email system comprises a spam button configured to extract data concerning an email and report said email as spam to said one or more certificate authorities.

7. The system of claim 1, wherein said email client is connected to a network.

8. A system for eliminating spam, comprising:
a certificate authority, wherein said certificate authority is configured to receive spam reports from one or more email clients.

9. The system of claim 8, further comprising a certificate account with said certificate authority for an advertiser.

10. The system of claim 8, wherein said certificate authority is connected to a network.

11. The system of claim 8, wherein said certificate authority is configured to receive said spam reports by email.

12. The system of claim 8, wherein said certificate authority is configured to receive said spam reports via a network connection to said certificate authority.

13. A method for eliminating spam, comprising:
receiving email;
determining if said email is spam; and
processing email determined to be spam.

14. The method of claim 13, wherein said determining is performed by:
checking said email for an anti-spam digital certificate;
if said email is found to have an anti-spam digital certificate, determining if said certificate is revoked; and
if said certificate is revoked, or if said email has no anti-spam digital certificate, classifying said email as spam.

15. The method of claim 14, wherein said determining further comprises:
checking if said email has been blocked; and
if said email has been blocked, classifying said email as spam.

16. The method of claim 13, wherein said processing comprises:
forwarding said email to a user-defined folder; or
deleting said email.

17. The method of claim 13, further comprising:
classifying said email according to said digital certificate if said email contains a digital certificate and if said digital certificate has not been revoked; and
processing said email according to classification of said email.

18. The method of claim 17, wherein said processing comprises:
forwarding said email to a user-defined folder.

19. The method of claim 14, wherein said determining if said certificate is revoked comprises:
accessing a certificate revocation list of a certificate authority of said digital certificate.

20. The method of claim 14, further comprising:
reporting as spam an unwanted email with a non-revoked digital certificate to a certificate authority that issued said non-revoked digital certificate.

21. The method of claim 20, wherein said reporting comprises:
establishing a connection via a network with the certificate authority and directly reporting the spam to the certificate authority.

22. The method of claim 20, wherein said reporting comprises:
sending an email message to said certificate authority.

23. The method of claim 14, further comprising:
if said certificate is revoked, or if said email has no anti-spam digital certificate, sending an auto-response email to the sender of said email.

24. The method of claim 20, wherein said reporting as spam blocks the sender of said email.

25. A method for eliminating spam, comprising:
issuing a digital certificate to an advertiser;
establishing a certificate account for said advertiser;
receiving a spam report from an email recipient; and
deducting a value from said certificate account.

26. The method of claim 24, further comprising:
revoking said digital certificate when said certificate account reaches zero.

27. The method of claim 24, wherein said receiving comprises:
receiving an email message from said recipient.

28. The method of claim 24, wherein said receiving comprises:
receiving a report via a network connection.

29. A method for sending email advertisements, comprising:
obtaining an anti-spam digital certificate from a certificate authority;
obtaining a certificate account with said certificate authority;
digitally signing an email advertisement with said digital certificate; and
sending said email advertisement to an end user email client.

30. The method of claim 28, wherein said sending said email continues until said certificate account reaches a balance of zero.

31. The method of claim 28, wherein said digital certificate contains a classification according to the content of said email advertisement.

32. A method for managing email advertisements, comprising:
receiving an email advertisement;
checking said email for an anti-spam digital certificate;
if said email is found to have an anti-spam digital certificate, determining if said certificate is revoked;
if said certificate is revoked, or if said email has no anti-spam digital certificate, classifying said email as spam and processing said spam;
if said certificate is not revoked, processing said email according to a products or services classification on said certificate.

33. The method of claim 31, wherein said processing comprises forwarding said email to a user-defined folder.

34. A method for sending email advertisements, comprising:
receiving from an end user a digitally signed request to receive email advertisements; and
sending a digitally signed email advertisement.

35. The method of claim 34, further comprising:
obtaining a digital certificate from a certificate authority; and
obtaining a certificate account with said certificate authority.

36. A system for receiving email advertisements, comprising:
a digitally signed request to receive email advertisements; and
an email client configured to communicate with one or more certificate authorities.

37. A method for receiving email advertisements, comprising:
sending to an advertiser a digitally signed request to receive email advertisements:
receiving from said advertiser a digitally signed email advertisement having a digital certificate;
determining whether said digital certificate has been revoked; and
if said digital certificate has been revoked, classifying said email as spam and processing said spam.

38. A method for verifying the authority to sell an email address, comprising:
receiving from an end user a digitally signed request to sell an email address;
digitally signing said request;
selling said email address to a third party; and
obtaining said third party's digital signature on said request.

39. The method of claim 38, further comprising:
attaching said request to an email advertisement; and
sending said email advertisement to said end user.

40. The method of claim 38, wherein said request has a limited number of permitted sales.
